(19) United States
(12) Patent Application Publication
(10) Pub. No.: US 2006/0211802 A1
(43) Pub. Date: Sep. 21, 2006

(54) Porous sintered metal-containing materials

(76) Inventor: Soheil Asgari, Wiesbaden (DE)

Correspondence Address: DORSEY & WHITNEY LLP;INTELLECTUAL PROPERTY DEPARTMENT, 250 PARK AVENUE, NEW YORK, NY, 10177, US

(21) Appl. No.: 11/385,145

(22) Filed: Mar. 20, 2006

Related U.S. Application Data
(60) Provisional application No. 60/663,335, filed on Mar. 18, 2005.

(51) Int. Cl. C08K 3/08

(52) U.S. Cl. 524/439

(57) ABSTRACT

A process for manufacturing a porous metal-containing material is provided. For example, a composition is provided comprising particles dispersed in at least one solvent, the particles comprising at least one polymer material and at least one metal-based compound. The solvent can be substantially removed from the composition, and the polymer material can be substantially decomposed, thereby converting the solvent-free particles into a porous metal-containing material. In addition, metal-containing materials produced in accordance with the above process and their use in implantable medical devices can be provided.

### CROSS-REFERENCE TO RELATED APPLICATION(S)

This application claims priority from U.S. Patent Application No. 60/663,335, filed Mar. 18, 2005, the entire disclosure of which is incorporated herein by reference.

### FIELD OF THE INVENTION

The present invention relates to a process for the manufacture of porous sintered metal-containing materials. The process can include preparing particles that include a polymer material and at least one metal-based compound, where the particles may be dispersed in a solvent, substantially removing the solvent, and treating the substantially solvent-free particles at temperatures where the polymer can be substantially decomposed, thereby converting the particles into a solid porous metal-containing material. The exemplary inventive materials can be used as coatings or bulk materials for various purposes including, e.g., coated medical implant devices.

### BACKGROUND OF THE INVENTION

Porous metal-based ceramic materials such as cermets can be used to form components for, e.g., friction-type bearings, filters, fumigating devices, energy absorbers or flame barriers. Structural elements having hollow space profiles and increased stiffness can also be important in a construction technology. Porous metal-based materials are becoming increasingly important in the field of coatings, and the functionalization of such materials with specific physical, electrical, magnetic and/or optical properties is of major interest. Furthermore, these materials can play an important role in applications such as photovoltaics, sensor technology, catalysis, and electro-chromatic display techniques.

Generally, there may be a need for porous metal-based materials having nano-crystalline fine structures, which may allow for tailoring of the electrical resistance, thermal expansion, heat capacity and conductivity, as well as superelastic properties, hardness, and mechanical strength.

Furthermore, there may be a need for porous metal-based materials which can be produced in a cost-efficient manner. Conventional porous metal-based materials and cermets can be produced by powder or melt-sintering methods, or by infiltration methods. Such methods can be technically and economically complex and costly, particularly since the control of the desired material properties can often depend on the size of the metal particles used. The metal particle size may not always be adjustable over an adequate range in certain applications such as coatings, where process technology such as, e.g., powder coating or tape casting may be used. Porous metals and metal-based materials may typically be made using conventional methods by the addition of additives or by foaming methods, which normally require the addition of pore-formers or blowing agents.

Also, there may be a need for porous metal-based materials where the pore size, the pore distribution, and the degree of porosity can be adjusted without deteriorating the physical and/or chemical properties of the material. Conventional methods based on fillers or blowing agents, for example, can provide porosity in the range of about 20-50%. However, the mechanical properties such as hardness and strength may decrease rapidly with increasing degree of porosity. This may be particularly disadvantageous in biomedical applications such as implants, where anisotropic pore distribution, large pore sizes, and a high degree of porosity may be required, together with long-term stability with respect to biomechanical stresses.

In the field of biomedical applications, it may be important to use biocompatible materials. For example, metal-based materials for use in drug delivery devices, which can be used for marking purposes or as absorbents for radiation, can preferably have a high degree of functionality and may combine significantly different properties in one material. In addition to specific magnetic, electrical, dielectric or optical properties, the materials may have to provide a high degrees of porosity in suitable ranges of pore sizes.

### SUMMARY OF EXEMPLARY EMBODIMENTS OF THE INVENTION

One object of the present invention is to provide a material based on metallic precursors which can be modifiable in its properties and composition, which allows for the tailoring of the mechanical, thermal, electrical, magnetic and/or optical properties thereof.

Another object of the present invention is to provide porous metal-containing materials at relatively low temperatures, wherein the porosity of the formed material can be reproducibly varied for use in a range of applications without adversely affecting the physical and/or chemical stability.

A further object of the present invention is to provide a porous material which may be used as a coating or as a bulk material, and a process for the production thereof.

Still another object of the present invention is to provide a material obtainable by a process such as those described herein, which may be in the form of a coating or in the form of a porous bulk material.

A still further object of the present invention is to provide a porous sintered metal-based material, obtainable by the processes as described herein, which may have bioerodible or biodegradable properties, and/or which may be at least partially dissolvable in the presence of physiologic fluids.

Yet a further object of the present invention is to provide porous metal-containing materials for use in the biomedical field as, e.g., implants, drug delivery devices, and/or coatings for implants and drug delivery devices.

In one further exemplary embodiment of the present invention, a process can be provided for the manufacture of porous metal-containing materials wherein a composition is provided that can include particles dispersed in one or more solvents, where the particles may include a polymer material and a metal-based compound. The solvent can then be substantially removed from the composition, and the polymer material may then be substantially decomposed, thereby converting the solvent-free particles into a porous metal-containing material.

According to a further exemplary embodiments of the process of the invention, the particles may include polymer-encapsulated metal-based compounds, polymer particles that may be at least partially coated with one or more metal-based compounds, or any mixtures thereof, where the particles may be produced in a solvent-based polymerization reaction.

In yet another exemplary embodiment of the present invention, the particles in the processes described above may include one or more metal-based compounds encapsulated in a polymer shell or capsule. The particles may be prepared by first providing an emulsion, suspension or dispersion of at least one polymerizable component in one or more solvents, adding a metal-based compound to the emulsion, suspension or dispersion, and polymerizing the polymerizable component, thereby forming the polymer-encapsulated metal-based compounds.

According to still another exemplary embodiment of the present invention, the particles in the processes described above may include one or more polymer particles coated with a metal-based compound. The particles may be prepared by providing an emulsion, suspension or dispersion of one or more polymerizable components in a solvent, and polymerizing the polymerizable components, thereby forming an emulsion, suspension or dispersion of polymer particles. One or more metal-based compounds may be added to the emulsion, suspension or dispersion, thereby forming polymer particles coated with the metal-based compounds.

These and other embodiments of the present invention are described by or encompassed by the detailed description provided herein.

### DETAILED DESCRIPTION OF EXEMPLARY EMBODIMENTS OF THE INVENTION

In certain exemplary embodiments of the present invention, metal-based compounds may be encapsulated in a polymer material to form particles. This can be accomplished, e.g., by the use of conventional solvent-based polymerization techniques. The particles may include one or more metal-based compounds encapsulated in a polymer shell or capsule. The particles can be prepared by providing an emulsion, suspension or dispersion of polymerizable monomers and/or oligomers and/or prepolymers in a solvent, adding at least one metal-based compound into the emulsion, suspension or dispersion, and polymerizing the monomers, oligomers and/or prepolymers, thereby forming polymer-encapsulated metal-based compounds.

In another exemplary embodiment of the present invention, particles of polymer material may be combined with and/or partially coated with metal-based compounds. The polymer particles coated with metal-based compounds may be prepared by providing an emulsion, suspension or dispersion of polymerizable components such as monomers, oligomers and/or prepolymers in a solvent and polymerizing the monomers, oligomers and/or prepolymers, thereby forming an emulsion, suspension or dispersion of polymer particles. One or more metal-based compounds may be added to the emulsion, suspension or dispersion, thereby forming polymer particles that may be at least partially coated with the metal-based compounds.

Certain exemplary embodiments of the present invention may include the addition of metal-based compounds to the reaction mixture at different times during the preparation of the particles described above. The metal-based compounds may be added before or during the polymerization step or, alternatively, thy may be added after the polymer particles have already formed in the reaction mixture.

Thus, porous sintered metals, alloys, oxides, hydroxides, ceramic materials and/or composite materials may be produced from metal-based compounds, including metal-based nanoparticles, in accordance with certain exemplary embodiments of the present invention. The porosity and pore sizes of the resulting material can be reproducibly and reliably controlled over wide ranges by, e.g., appropriate selection of the polymers and/or metal-based compounds used, their structure, molecular weights, and the overall content of solids in the reaction mixture. Mechanical, tribological, electrical, and/or optical properties also be varied by, e.g., controlling the process conditions in the polymerization reaction, the solids content of the reaction mixtures, or the type and/or composition of the metal-based compounds.

The metal-based compounds may be selected from zero-valent metals, metal alloys, metal oxides, inorganic metal salts, particularly salts from alkaline and/or alkaline earth metals and/or transition metals, preferably alkaline or alkaline earth metal carbonates, sulphates, sulfites, nitrates, nitrites, phosphates, phosphites, halides, sulfides, oxides, as well as mixtures thereof; organic metal salts, particularly alkaline or alkaline earth and/or transition metal salts, including their formiates, acetates, propionates, malates, maleates, oxalates, tartrates, citrates, benzoates, salicylates, phtalates, stearates, phenolates, sulfonates, and/or amines as well as mixtures thereof; organometallic compounds, metal alkoxides, semiconductive metal compounds, metal carbides, metal nitrides, metal oxynitrides, metal carbonitrides, metal oxycarbides, metal oxynitrides, or metal oxycarbonitrides, including those of transition metals; metal-based core-shell nanoparticles, which may include CdSe or CdTe as a core material and CdS or ZnS as a shell material; metal-containing endohedral fullerenes and/or endometallofullerenes, including those of rare earth metals such as cerium, neodymium, samarium, europium, gadolinium, terbium, dysprosium, holmium; as well as any combinations of any of the foregoing.

In certain exemplary embodiments of the present invention, solders and/or brazing alloys may be excluded from the metal-based compounds.

In further exemplary embodiments of the present invention, the metal-based compounds of the above mentioned materials may be provided in the form of nanocrystalline or microcrystalline particles, powders or nanowires. The metal-based compounds may have an average particle size of about 0.5 nm to 1.000 nm, preferably about 0.5 nm to 900 nm, or more preferably about 0.7 nm to 800 nm.

The metal-based compounds to be encapsulated by polymers or coated on polymer particles can also be provided as mixtures of metal-based compounds, particularly nanoparticles thereof having different characteristics. The metal-based compounds may be selected based on the desired properties of the porous metal-containing material to be produced. The metal-based compounds may be provided in the form of powders, in solutions in polar, non-polar or amphiphilic solvents or in solvent or solvent-surfactant mixtures, or in the form of sols, colloidal particles, dispersions, suspensions or emulsions.

Properties of nanoparticles of the above-mentioned metal-based compounds may be easier to modify than those of larger particles because of their larger surface to volume ratio. The metal-based compounds, particularly nanoparticles, may be modified, for example, with hydrophilic ligands such as, e.g., trioctylphosphine, in a covalent or non-covalent manner.

Examples of ligands that may be covalently bonded to metal nanoparticles include, e.g., fatty acids, thiol fatty acids, amino fatty acids, fatty acid alcohols, fatty acid ester groups, any mixtures thereof such as, for example, oleic acid and oleylamine, or similar conventional organometallic ligands.

The metal-based compounds may be selected from metals or metal-containing compounds such as, for example, hydrides, inorganic or organic salts, oxides and the like, as described above. Depending on the thermal treatment conditions and the process conditions used in the exemplary embodiments of the present invention, porous oxidized or zero-valet metals may be produced from the metal compounds used in combination with the polymer particles or capsules.

In certain exemplary embodiments of the present invention, metal-based compounds may include, but are not limited to, powders of zero-valent-metals, including nanomorphous nanoparticles, metal oxides or combinations thereof; metals and compounds of metal present in the main group of metals in the periodic table, transition metals such as copper, gold and silver, titanium, zirconium, hafnium, vanadium, niobium, tantalum, chromium, molybdenum, tungsten, manganese, rhenium, iron, cobalt, nickel, ruthenium, rhodium, palladium, osmium, iridium or platinum; or rare earth metals.

The metal-based compounds which may be used include, e.g., iron, cobalt, nickel, manganese or mixtures thereof, such as iron-platinum-mixtures. Magnetic metal oxides may also be used such as, for example, iron oxides and ferrites. To provide materials having magnetic or signaling properties, magnetic metals or alloys may be used, such as, e.g., ferrites, gamma-iron oxide, magnetite, or ferrites of Co, Ni, or Mn. Examples of such materials are described in International Patent Publications WO83/03920, WO83/01738, WO85/02772, WO88/00060, WO89/03675, WO90/01295 and WO90/01899, and in U.S. Pat.Nos. 4,452,773; 4,675,173; and 4,770,183.

In further exemplary embodiments of the present invention, semiconducting compounds and/or nanoparticles may be used including, e.g., semiconductors of groups II-VI, groups III-V, or group IV of the periodic table. Suitable group II-VI-semiconductors include, for example, MgS, MgSe, MgTe, CaS, CaSe, CaTe, SrS, SrSe, SrTe, BaS, BaSe, BaTe, ZnS, ZnSe, ZnTe, CdS, CdSe, CdTe, HgS, HgSe, HgTe or mixtures thereof. Examples of group III-V semiconductors include, for example, GaAs, GaN, GaP, GaSb, InGaAs, InP, InN, InSb, InAs, AlAs, AlP, AlSb, AlS, or mixtures thereof. Examples of group IV semiconductors include germanium, lead and silicon. Combinations of any of the foregoing semiconductors may also be used.

In certain exemplary embodiments of the present invention, the metal-based compounds may include complex metal-based nanoparticles. These may include core/shell configurations, which are described, e.g., in Peng et al., Epitaxial Growth of Highly Luminescent CdSe/CdS Core/Shell Nanoparticles with Photostability and Electronic Accessibility, Journal of the American Chemical Society (1997), 119, pp. 7019-7029.

Semiconducting nanoparticles may be formed from one or more of the semiconducting materials and compounds listed above. These nanoparticles may include a core with a diameter of about 1 to 30 nm, or preferably about 1 to 15 nm, upon which further semiconducting nanoparticles may be crystallized to a depth of about 1 to 50 monolayers, or preferably about 1 to 15 monolayers. Cores and shells may be present in nearly any combination of the materials as listed above, including CdSe or CdTe cores, and CdS or ZnS shells.

In a further exemplary embodiment of the present invention, the metal-based compounds may be selected based on their absorptive properties for radiation in a wavelength ranging from gamma radiation up to microwave radiation, or based on their abilitiy to emit radiation, particularly in the wavelength region of about 60 nm or less. By suitably selecting the metal-based compounds, materials having non-linear optical properties may be produced. Such metal-based compounds may include, for example, materials that can block IR-radiation of specific wavelengths, which may be suitable for marking purposes or to form therapeutic radiation-absorbing implants. The metal-based compounds and their particle sizes and their core and shell diameters may be selected to provide photon emitting compounds, such that the emission may be in the range of about 20 nm to 1000 nm. Alternatively, a mixture of suitable compounds may be selected which emits photons of differing wavelengths when exposed to radiation. In one exemplary embodiment of the present invention, fluorescent metal-based compounds may be selected that do not require quenching.

Metal-based compounds that may be used in further exemplary embodiments of the present invention include nanoparticles in the form of nanowires, which may include any metal, metal oxide, or mixture thereof, and which may have diameters in the range of about 2 nm to 800 nm, or preferably about 5 nm to 600 nm.

In further exemplary embodiments of the present invention, the metal-based compound may be selected from metallofullerenes or endohedral carbon nanoparticles that include a metal compound such as those mentioned above. Particularly preferred metal-based compounds may include, e.g., endohederal fullerenes or endometallofullerenes, which may include rare earth metals such as cerium, neodynium, samarium, europium, gadolinium, terbium, dysprosium, holmium, and the like. Endohedral metallofullerenes may also include transition metals such as those described above. Endohedral fullerenes which may be used for marker purposes can include those that are further described in U.S. Pat. No. 5,688,486 and International Patent Publication WO 93/15768.

Carbon-coated metal nanoparticles that include carbides may also be used as the metal-based compound. Metal-containing nanomorphous carbon species such as nanotubes, onions; as well as metal-containing soot, graphite, diamond particles, carbon black, carbon fibres and the like may also be used in further exemplary embodiments of the present invention.

Metal-based compounds which may be used for biomedical applications can include alkaline earth metal oxides or hydroxides such as, e.g., magnesium oxide, magnesium hydroxide, calcium oxide, calcium hydroxide, or mixtures thereof.

The metal-based compounds such as those described above may be encapsulated in a polymeric shell or capsule. The encapsulation of the metal-based compounds in polymers may be achieved by various conventional solvent polymerization techniques such as, e.g. dispersion, suspension, or emulsion polymerization. Encapsulating polymers include, but are not limited to, polymethylmethacrylate (PMMA), polystyrol, polyvinyl acetate, or other latex-forming polymers. The polymer capsules which contain the metal-based compounds can further be modified, for example, by linking lattices, by further encapsulation with polymers, or by further coating them with elastomers, metal oxides, metal salts or other suitable metal compounds, e.g., metal alkoxides. Conventional techniques may optionally be used to modify the polymers, and may be employed depending on the requirements of the individual compositions to be used.

The use of encapsulated metal-based compounds may prevent aggregation of the metals. When applied to molds or onto substrates, the polymer shells can provide a three-dimensional pattern of metal centers spaced apart from each other by the polymer material, which may lead to a highly porous precursor structure that may be at least partly preserved in the thermal decomposition step. Thus, after the polymer has completely decomposed, a porous sintered metal structure can remain. Similar considerations may apply when using metal-coated polymer particles. Thus it is possible to control the pore size and/or overall porosity of the resulting sintered metal materials by controlling the size of the metal-containing polymer particles or capsules, which can be achieved by selecting suitable reaction conditions and parameters for the polymerization process.

The porosity and pore sizes of the resultant metal-containing sintered materials may be adjusted to desired values over a wide range. Certain exemplary embodiments of the present invention may allow for production of sintered metal-containing materials having a pore size in the micro-, meso- or macro-porous range. Average pore sizes that may be achieved using the processes described herein can be about 1 nm, preferably at least about 5 nm, more preferably at least about 10 nm or at least about 100 nm. Average pore sizes may be provided in the range of about 1 nm to about 400 μm, preferably about 1 nm to 80 μm, or more preferably about 1 nm to about 40 μm. In the macroporous region, pore sizes may range from about 500 nm to 400 μm, preferably from about 500 nm to about 80 μm, from about 500 nm to about 40 μm, or from 500 nm to about 10 μm. The metal-containing sintered materials may have an average porosity of about 30% to about 80%.

Encapsulation of the metal-based compounds can be covalent or non-covalent, depending on the particular components used. The encapsulated metal-based compounds may be provided in the form of polymer spheres such as, e.g., micro spheres, or in the form of dispersed, suspended or emulsified particles or capsules.

Conventional methods may be utilized to provide encapsulated metal-based compounds or polymer particles, and dispersions, suspensions emulsions or miniemulsions thereof. Suitable encapsulation methods are described, for example, in Australian Patent Publication AU 9169501, European Patent Publications EP 1205492, EP 1401878, EP 1352915 and EP 1240215, U.S. Pat. No. 6,380,281, U.S. Patent Publication 2004192838, Canadian Patent Publication CA 1336218, Chinese Patent Publication CN 1262692T, British Patent Publication GB 949722, and German Patent Publication DE 10037656; and in S. Kirsch, K. Landfester, 0. Shaffer and M. S. El-Aasser, “Particle morphology of carboxylated poly-(n-butyl acrylate)/(poly(methyl methacrylate) composite latex particles investigated by TEM and NMR,” Acta Polymerica 1999, 50, 347-362; K. Landfester, N. Bechthold, S. Förster and M. Antonietti, “Evidence for the preservation of the particle identity in miniemulsion polymerization,” Macromol. Rapid Commun. 1999, 20, 81-84; K. Landfester, N. Bechthold, F. Tiarks and M. Antonietti, “Miniemulsion polymerization with cationic and nonionic surfactants: A very efficient use of surfactants for heterophase polymerization,” Macromolecules 1999, 32, 2679-2683; K. Landfester, N. Bechthold, F. Tiarks and M. Antonietti, “Formulation and stability mechanisms of polymerizable miniemulsions,” Macromolecules 1999, 32, 5222-5228; G. Baskar, K. Landfester and M. Antonietti, “Comb-like polymers with octadecyl side chain and carboxyl functional sites: Scope for efficient use in miniemulsion polymerization,” Macromolecules 2000, 33, 9228-9232; N. Bechthold, F. Tiarks, M. Willert, K. Landfester and M. Antonietti, “Miniemulsion polymerization: Applications and new materials,” Macromol. Symp. 2000, 151, 549-555; N. Bechthold and K. Landfester: “Kinetics of miniemulsion polymerization as revealed by calorimetry,” Macromolecules 2000, 33, 4682-4689; B. M. Budhlall, K. Landfester, D. Nagy, E. D. Sudol, V. L. Dimonie, D. Sagl, A. Klein and M. S. El-Aasser, “Characterization of partially hydrolyzed poly(vinyl alcohol). I. Sequence distribution via H-1 and C-13-NMR and a reversed-phased gradient elution HPLC technique,” Macromol. Symp. 2000, 155, 63-84; D. Columbie, K. Landfester, E. D. Sudol and M. S. El-Aasser, “Competitive adsorption of the anionic surfactant Triton X-405 on PS latex particles,” Langmuir 2000, 16, 7905-7913; S. Kirsch, A. Pfau, K. Landfester, O. Shaffer and M. S. El-Aasser, “Particle morphology of carboxylated poly-(n-butyl acrylate)/poly(methyl methacrylate) composite latex particles,” Macromol. Symp. 2000, 151, 413-418; K. Landfester, F. Tiarks, H.-P. Hentze and M. Antonietti, “Polyaddition in miniemulsions: A new route to polymer dispersions,” Macromol. Chem. Phys. 2000, 201, 1-5; K. Landfester, “Recent developments in miniemulsions—Formation and stability mechanisms,” Macromol. Symp. 2000, 150, 171-178; K. Landfester, M. Willert and M. Antonietti, “Preparation of polymer particles in non-aqueous direct and inverse miniemulsions,” Macromolecules 2000, 33, 2370-2376; K. Landfester and M. Antonietti, “The polymerization of acrylonitrile in miniemulsions: ‘Crumpled latex particles’ or polymer nanocrystals,” Macromol. Rapid Comm. 2000, 21, 820-824; B. z. Putlitz, K. Landfester, S. Förster and M. Antonietti, “Vesicle forming, single tail hydrocarbon surfactants with sulfonium-headgroup,” Langmuir 2000, 16, 3003-3005; B. z. Putlitz, H.-P. Hentze, K. Landfester and M. Antonietti, “New cationic surfactants with sulfonium-headgroup,” Langmuir 2000, 16, 3214-3220; J. Rottstegge, K. Landfester, M. Wilhelm, C. Heldmann and H. W. Spiess, “Different types of water in film formation process of latex dispersions as detected by solid-state nuclear magnetic resonance spectroscopy,” Colloid Polym. Sci. 2000, 278, 236-244; K. Landfester and H.-P. Hentze, “Heterophase polymerization in inverse systems,” in Reactions and Synthesis in Surfactant Systems, J. Texter, ed., Marcel Dekker, Inc., New York, 2001, pp 471-499; K. Landfester, “Polyreactions in miniemulsions,” Macromol. Rapid Comm. 2001, 896-936; K. Landfester, “The generation of nanoparticles in miniemulsion,” Adv. Mater. 2001, 10, 765-768; B. z. Putlitz, K. Landfester, H. Fischer and M. Antonietti, “The generation of ‘armored latexes’ and hollow inorganic shells made of clay sheets by templating cationic miniemulsions and latexes,” Adv. Mater. 2001, 13, 500-503; F. Tiarks, K. Landfester and M. Antonietti, “Preparation of polymeric nanocapsules by miniemulsion polymerization,” Langmuir 2001, 17, 908-917; F. Tiarks, K. Landfester and M. Antonietti, “Encapsulation of carbon black by miniemulsion polymerization,” Macromol. Chem. Phys. 2001, 202, 51-60; F. Tiarks, K. Landfester and M. Antonietti, “One-step preparation of polyurethane dispersions by miniemulsion polyaddition,” J. Polym. Sci., Polym. Chem. Ed. 2001, 39, 2520-2524; and in F. Tiarks, K. Landfester and M. Antonietti, “Silica nanoparticles as surfactants and fillers for latexes made by miniemulsion polymerization,” Langmuir 2001, 17, 5775-5780.

Polymerization methods such as those described above may be used with the exemplary embodiments of the present invention. The metal-based compounds may be added to the polymerization mixture before, during or after the selected polymerization reaction.

The encapsulated metal-based compounds may be produced in a size of about 1 nm to 500 nm, or in the form of microparticles having sizes from about 5 nm to 5 μm. Metal-based compounds may be further encapsulated in mini- or micro-emulsions of suitable polymers. The term mini- or micro-emulsion can refer to dispersions that include an aqueous phase, an oil phase, and surface active substances, i.e., surfactants. Such emulsions may include water, one or several surfactants, optionally one or several co-surfactants, and one or several hydrophobic substances such as, e.g., suitable oils. Mini-emulsions may include aqueous emulsions of monomers, oligomers or other pre-polymeric reactants that may be stabilized by surfactants and which may be easily polymerized, where the particle size of the emulsified droplets may be about 10 nm to 500 nm or larger.

The size of the particles formed in reactions such as those described above may be controlled, e.g., by the kind and/or amount of surfactant added to the monomer mixture. Lower surfactant concentrations may yield larger particle sizes of the polymer particles or capsules. The amount of surfactant used in the polymerization reaction can be a suitable parameter for adjusting the pore size and/or overall porosity of the resulting porous metal-containing material.

Mini-emulsions of encapsulated metal-based compounds can be made from non-aqueous media such as, for example, formamide, glycol, or non-polar solvents. Pre-polymeric reactants may be selected from thermosets, thermoplastics, plastics, synthetic rubbers, extrudable polymers, injection molding polymers, moldable polymers and the like, or mixtures thereof, including pre-polymeric reactants from which poly(meth)acrylics can be formed.

Examples of polymers suitable for encapsulating the metal-based compounds or for being coated with metal-based compounds include, but are not limited to, homopolymers or copolymers of aliphatic or aromatic polyolefins such as polyethylene, polypropylene, polybutene, polyisobutene, polypentene; polybutadiene; polyvinyls such as polyvinyl chloride or polyvinyl alcohol, poly(meth)acrylic acid, polymethylmethacrylate (PMMA), polyacrylocyano acrylate; polyacrylonitril, polyamide, polyester, polyurethane, polystyrene, polytetrafluoroethylene; biopolymers such as collagen, albumin, gelatin, hyaluronic acid, starch, celluloses such as methylcellulose, hydroxypropyl cellulose, hydroxypropyl methylcellulose, carboxymethylcellulose phthalate; casein, dextranes, polysaccharides, fibrinogen, poly(D,L-lactides), poly(D,L-lactide coglycolides), polyglycolides, polyhydroxybutylates, polyalkyl carbonates, polyorthoesters, polyesters, polyhydroxyvaleric acid, polydioxanones, polyethylene terephthalates, polymaleate acid, polytartronic acid, polyanhydrides, polyphosphazenes, polyamino acids; polyethylene vinyl acetate, silicones; poly(ester urethanes), poly(ether urethanes), poly(ester ureas), polyethers such as polyethylene oxide, polypropylene oxide, pluronics, polytetramethylene glycol; polyvinylpyrrolidone, poly(vinyl acetate phthalate), shellac, or combinations of these homopolymers or copolymers. In certain exemplary embodiments of the present invention, the polymer material may not include polyurethanes, i.e. the polymer material does not include polyurethane materials or their monomers, oligomers or prepolymers.

Further encapsulating materials that can be used may include poly(meth)acrylate, unsaturated polyester, saturated polyester, polyolefines such as polyethylene, polypropylene, polybutylene, alkyd resins, epoxy-polymers or resins, polyamide, polyimide, polyetherimide, polyamideimide, polyesterimide, polyesteramideimide, polyurethane, polycarbonate, polystyrene, polyphenole, polyvinylester, polysilicone, polyacetale, cellulosic acetate, polyvinylchloride, polyvinylacetate, polyvinylalcohol, polysulfone, polyphenylsulfone, polyethersulfone, polyketone, polyetherketone, polybenzimidazole, polybenzoxazole, polybenzthiazole, polyfluorocarbons, polyphenylenether, polyarylate, cyanatoester-polymere, or mixtures or copolymers of any of the foregoing.

In certain exemplary embodiments of the present invention, the polymers for encapsulating the metal-based compounds may be selected from mono(meth)acrylate, di(meth)acrylate, tri(meth)acrylate, tetra-acrylate, or pentaacrylate-based poly(meth)acrylates. Examples of suitable mono(meth)acrylates may include hydroxyethyl acrylate, hydroxyethyl methacrylate, hydroxypropyl methacrylate, hydroxypropyl acrylate, 3-chloro-2-hydroxypropyl acrylate, 3-chloro-2-hydroxypropyl methacrylate, 2,2-dimethylhydroxypropyl acrylate, 5-hydroxypentyl acrylate, diethylene glycol monoacrylate, trimethylolpropane monoacrylate, pentaerythritol monoacrylate, 2,2-dimethyl-3-hydroxypropyl acrylate, 5-hydroxypentyl methacrylate, diethylene glycol monomethacrylate, trimethylolpropane monomethacrylate, pentaerythritol monomethacrylate, hydroxy-methylated N-(1,1-dimethyl-3-oxobutyl)acrylamide, N-methylolacrylamide, N-methylolmethacrylamide, N-ethyl-N-methylolmethacrylamide, N-ethyl-N-methylolacrylamide, N,N-dimethylol-acrylamide, N-ethanolacrylamide, N-propanolacrylamide, N-methylolacrylamide, glycidyl acrylate, and glycidyl methacrylate, methyl acrylate, ethyl acrylate, propyl acrylate, butyl acrylate, amyl acrylate, ethylhexyl acrylate, octyl acrylate, t-octyl acrylate, 2-methoxyethyl acrylate, 2-butoxyethyl acrylate, 2-phenoxyethyl acrylate, chloroethyl acrylate, cyanoethyl acrylate, dimethylaminoethyl acrylate, benzyl acrylate, methoxybenzyl acrylate, furfuryl acrylate, tetrahydrofurfuryl acrylate and phenyl acrylate. Di(meth)acrylates may be selected from 2,2-bis(4-methacryloxyphenyl)propane, 1,2-butanediol-diacrylate, 1,4-butanediol-diacrylate, 1,4-butanediol-dimethacrylate, 1,4-cyclohexanediol-dimethacrylate, 1,10-decanediol-dimethacrylate, diethylene-glycol-diacrylate, dipropyleneglycol-diacrylate, dimethyl-propanediol-dimethacrylate, triethyleneglycol-dimethacrylate, tetraethyleneglycol-dimethacrylate, 1,6-hexanediol-diacrylate, Neopentylglycol-diacrylate, polyethylene-glycol-dimethacrylate, tripropyleneglycol-diacrylate, 2,2-bis[4-(2-acryloxyethoxy)-phenyl]propane, 2,2-bis[4-(2-hydroxy-3-methacryloxypropoxy)phenyl]propane, bis(2-methacryloxyethyl)N,N-1,9-nonylene-biscarbamate, 1,4-cycloheanedimethanol-dimethacrylate, or diacrylic urethane oligomers. Tri(meth)acrylates may be selected from tris(2-hydroxyethyl)isocyanurate-trimethacrylate, tris(2-hydroxyethyl)-isocyanurate-triacrylate, trimethylolpropane-trimethacrylate, trimethylolpropane-triacrylate or pentaerythritol-triacrylate. Tetra(meth)acrylates may be selected from pentaerythritol-tetraacrylate, di-trimethylopropan-tetraacrylate, or ethoxylated pentaerythritol-tetraacrylate. Suitable penta(meth)acrylates may be selected from dipentaerythritol-pentaacrylate or pentaacrylate-esters. Suitable polymers may also include mixtures, copolymers or combinations of any of the foregoing.

In medical applications, biopolymers or acrylics may be selected as polymers for encapsulating or for serving as a substrate for the metal-based compounds.

Encapsulating polymer reactants may be selected from polymerizable monomers, oligomers or elastomers such as, e.g., polybutadiene, polyisobutylene, polyisoprene, poly(styrene-butadiene-styrene), polyurethanes, polychloroprene, or silicone, and mixtures, copolymers or combinations of any of the foregoing. The metal-based compounds may be encapsulated in elastomeric polymers or in mixtures of thermoplastic and elastomeric polymers, or in a sequence of alternating thermoplastic and elastomeric polymer shells or layers.

The polymerization reaction for encapsulating the metal-based compounds may be any suitable conventional polymerization reaction such as, for example, a radical or non-radical polymerization, an enzymatic or non-enzymatic polymerization, or a poly-condensation reaction. The emulsions, dispersions or suspensions may be in the form of aqueous, non-aqueous, polar or non-polar systems. By adding suitable surfactants, the amount and size of the emulated or dispersed droplets can be adjusted as required. The surfactants may be anionic, cationic, zwitterionic or non-ionic surfactants or any combinations thereof. Preferred anionic surfactants may include, but are not limited to soaps, alkylbenzolsulphonates, alkansulphonates like e.g. sodium dodecylsulphonate (SDS) and the like, olefinsulphonates, alkyethersulphonates, glycerinethersulphonates, α-methylestersulphonates, sulphonated fatty acids, alkylsulphates, fatty alcohol ether sulphates, glycerine ether sulphates, fatty acid ether sulphates, hydroxyl mixed ether sulphates, monoglyceride(ether)sulphates, fatty acid amide(ether)sulphates, mono- and dialkylsulfosuccinates, mono- and dialkylsulfosuccinamates, sulfotriglycerides, amidsoaps, ethercarboxylicacid and their salts, fatty acid isothionates, fatty acid arcosinates, fatty acid taurides, N-acylaminoacids such as acyllactylates, acyltartrates, acylglutamates and acylaspartates, alkyoligoglucosidsulfates, protein fatty acid condensates, including plant derived products based on wheat; and alky(ether)phosphates.

In certain exemplary embodiments of the present invention, suitable cationic surfactants for encapsulation reactions may include, e.g., quaternary ammonium compounds such as dimethyldistearylammoniumchloride, Stepantex® VL 90 (Stepan), esterquats, quaternised fatty acid trialkanolaminester salts, salts of long-chain primary amines, quaternary ammonium compounds such as hexadecyltrimethylammoniumchloride (CTMA-Cl), Dehyquart® A (cetrimoniumchloride, Cognis), or Dehyquart® LDB 50 (lauryldimethylbenzylammoniumchloride, Cognis).

The metal-based compounds, which may be provided in the form of a metal-based sol, can be added before or during the start of the polymerization reaction, and may be provided as a dispersion, emulsion, suspension or solid solution, or solution of the metal-based compounds in a suitable solvent or solvent mixture, or any mixtures thereof. The encapsulation process can include a polymerization reaction, optionally with the use of initiators, starters or catalysts. In-situ encapsulation of the metal-based compounds in polymer capsules, spheroids or droplets produced by the polymerization may occur. The solids content of the metal-based compounds in such encapsulation mixtures may be selected such that the solids content in the polymer capsules, spheroids or droplets can be about 10 weight % to 80 weight % of the metal-based compound within the polymer particles.

The metal-based precursor compounds may also be added after completion of the polymerization reaction, either in a solid form or in a liquid form. The metal-based compounds can be bonded to or coated onto the polymer particles and at least partially cover the surface thereof. This can be achieved by stirring the metal-based compounds into the liquid polymer particle dispersion, which may result in a covalent or non-covalent binding or a physical adsorption to the polymer particles, spheroids or droplets. The droplet size of the polymers and/or the solids content of the metal-based compounds may be selected such that the solid content of the metal-based compounds is in the range of about 5 weight % to 60 weight %.

In an exemplary embodiment of the present invention, in-situ encapsulation of the metal-based compounds during the polymerization may be repeated by addition of further monomers, oligomers or pre-polymeric agents after completion of the first polymerization/encapsulation step. By repeating at least one such polymerization or encapsulating step, optionally using different components, multilayer coated polymer capsules may be produced. Metal-based compounds bound to or coated onto polymer spheroids or droplets may also be encapsulated by subsequently adding monomers, oligomers or pre-polymeric reactants to overcoat the metal-based compounds with a polymer capsule. Repetition of such process steps can provide multilayered polymer capsules that include the metal-based compound.

The encapsulation steps described above may be combined with one another in a single encapsulation process. In one exemplary embodiment of the present invention, polymer-encapsulated metal-based compounds may be further encapsulated with elastomeric compounds, so that polymer capsules having an outer elastomer shell may be produced.

In further exemplary embodiments of the present invention, polymer-encapsulated metal-based compounds may be further encapsulated in vesicles, liposomes, micelles, or overcoatings. Surfactants suitable for this purpose may include the surfactants described above, as well as compounds having hydrophobic groups that may include hydrocarbon residues or silicon residues such as, for example, polysiloxane chains, hydrocarbon-based monomers, oligomers and polymers, lipids or phosphorlipids, or any combinations thereof, including glycerylester, phosphatidyl-ethanolamine, phosphatidylcholine, polyglycolide, polylactide, polymethacrylate, polyvinylbuthylether, polystyrene, polycyclopenta-dienylmethylnorbornene, polypropylene, polyethylene, polyisobutylene, polysiloxane, or any other type of surfactant.

Surfactants suitable for encapsulating the polymer encapsulated metal-based compounds in vesicles, overcoats and the like may be selected from hydrophilic surfactants or surfactants having hydrophilic residues or hydrophilic polymers such as polystyrensulfonicacid, poly-N-alkylvinylpyridiniumhalogenide, poly(meth)acrylic acid, polyaminoacids, poly-N-vinylpyrrolidone, polyhydroxyethylmethacrylate, polyvinylether, polyethylenglycol, polypropylenoxide, polysaccharides such as agarose, dextrane, starch, cellulose, amylase, amylopektine or polyethylenglycole, or polyethylennimine of a suitable molecular weight. Also, mixtures of hydrophobic or hydrophilic polymer materials or lipid polymer compounds may be used for encapsulating the polymer capsulated metal-based compounds in vesicles or for further over-coating the polymer encapsulating metal-based compounds.

The incorporation of polymer-encapsulated metal-based compounds into the materials produced in accordance with exemplary embodiments of the present invention can be viewed as being a specific type of filler. The particle size and particle size distribution of the polymer-encapsulated metal-based compounds in dispersed or suspended form may correspond to the particle size and particle size distribution of the particles of finished polymer-encapsulated metal-based compounds, and they can influence the resultant pore sizes of the material produced. The polymer-encapsulated metal-based compounds can be characterized by dynamic light scattering methods to determine their average particle size and monodispersity.

In further exemplary embodiments of the present invention, the mechanical, optical and/or thermal properties of the sintered metal-containing material may be further adjusted or altered by the use of additives. Additives may be particularly suitable for producing certain coatings having desired properties. Such additives may be introduced into the polymerization mixture or into the dispersion of polymer particles, and they may not react with the components thereof.

Examples of suitable additives include, e.g., fillers, pore-forming agents, metals and metal powders, and the like. Examples of inorganic additives and fillers can include silicon oxides and aluminum oxides, aluminosilicates, zeolites, zirconium oxides, titanium oxides, talc, graphite, carbon black, fullerenes, clay materials, phyllosilicates, silicides, nitrides, or metal powders including those of catalytically active transition metals such as copper, gold, silver, titanium, zirconium, hafnium, vanadium, niobium, tantalum, chromium, molybdenum, tungsten, manganese, rhenium, iron, cobalt, nickel, ruthenium, rhodium, palladium, osmium, iridium or platinum.

Other suitable additives may include crosslinkers, plasticizers, lubricants, flame resistants, glass or glass fibers, carbon fibers, cotton, fabrics, metal powders, metal compounds, silicon, silicon oxides, zeolites, titan oxides, zirconium oxides, aluminium oxides, aluminium silicates, talcum, graphite, soot, phyllosilicates, etc.

Fillers can be used to modify the pore size and the degree of porosity. In certain exemplary embodiments of the present invention, non-polymeric fillers may be preferred. Non-polymeric fillers can be any substance which can be removed or degraded, for example, by thermal treatment or other conditions, without adversely affecting the material properties. Some fillers might be dissolved by a suitable solvent and can be removed in this manner from the material. Non-polymeric fillers that can be converted into soluble substances under appropriate thermal conditions may also be used. These non-polymeric fillers may include, for example, anionic, cationic or non-ionic surfactants, which can be removed or degraded under thermal conditions.

In another exemplary embodiment of the present invention, the fillers may include inorganic metal salts, particularly salts from alkaline and/or alkaline earth metals, including alkaline or alkaline earth metal carbonates, sulfates, sulfites, nitrates, nitrites, phosphates, phosphites, halides, sulfides, oxides, or mixtures thereof. Other suitable fillers may include organic metal salts such as, e.g., alkaline or alkaline earth and/or transition metal salts, including formiates, acetates, propionates, malates, maleates, oxalates, tartrates, citrates, benzoates, salicylates, phtalates, stearates, phenolates, sulfonates, or amines, as well as mixtures thereof.

In yet another exemplary embodiment of the present invention, polymeric fillers may be used. Suitable polymeric fillers can include encapsulation polymers described above, particularly those having the form of spheres or capsules. Saturated, linear or branched aliphatic hydrocarbons may also be used, and they may be homo- or copolymers. Polyolefins such as polyethylene, polypropylene, polybutene, polyisobutene or polypentene, as well as copolymers or mixtures thereof, may also be used. Polymeric fillers may also include polymer particles of methacrylates or polystearine, as well as electrically conducting polymers such as polyacetylenes, polyanilines, poly(ethylenedioxythiophenes), polydialkylfluorenes, polythiophenes or polypyrroles, which may be used to produce electrically conductive materials.

In some of the processes described above, soluble fillers may be used with polymeric fillers, where these fillers may be volatile under thermal processing conditions or may be converted into volatile compounds during thermal treatment. Pores formed by such polymeric fillers during thermal treatment can be combined with the pores formed by the other fillers to achieve an isotropic or anisotropic pore distribution. Particle sizes of the non-polymeric fillers can be chosen based on the desired porosity and/or size of the pores of the resulting composite material.

Solvents that can be used for the removal of the fillers after thermal treatment of the material may include, for example, water, hot water, diluted or concentrated inorganic or organic acids, bases, etc. Suitable inorganic acids can include, for example, hydrochloric acid, sulfuric acid, phosphoric acid, nitric acid, or diluted hydrofluoric acid. Suitable bases can include, for example, sodium hydroxide, ammonia, carbonate, as well as organic amines. Suitable organic acids can include, for example, formic acid, acetic acid, trichloromethane acid, trifluoromethane acid, citric acid, tartaric acid, oxalic acid, and mixtures thereof.

In certain exemplary embodiments of the present invention, coatings of the inventive composite materials may be applied as a liquid solution or dispersion or suspension of the combination in a suitable solvent or solvent mixture, with subsequent drying or evaporation of the solvent. Suitable solvents may include, for example, methanol, ethanol, N-propanol, isopropanol, butoxydiglycol, butoxyethanol, butoxyisopropanol, butoxypropanol, n-butyl alcohol, t-butyl alcohol, butylene glycol, butyl octanol, diethylene glycol, dimethoxydiglycol, dimethyl ether, dipropylene glycol, ethoxydiglycol, ethoxyethanol, ethyl hexane diol, glycol, hexane diol, 1,2,6-hexane triol, hexyl alcohol, hexylene glycol, isobutoxy propanol, isopentyl diol, 3-methoxybutanol, methoxydiglycol, methoxyethanol, methoxyisopropanol, methoxymethylbutanol, methoxy PEG-10, methylal, methyl hexyl ether, methyl propane diol, neopentyl glycol, PEG-4, PEG-6, PEG-7, PEG-8, PEG-9, PEG-6-methyl ether, pentylene glycol, PPG-7, PPG-2-buteth-3, PPG-2 butyl ether, PPG-3butyl ether, PPG-2 methyl ether, PPG-3 methyl ether, PPG-2 propyl ether, propane diol, propylene glycol, propylene glycol butyl ether, propylene glycol propyl ether, tetrahydrofurane, trimethyl hexanol, phenol, benzene, toluene, xylene; or water, any of which may be mixed with dispersants, surfactants or other additives, and mixtures of the above-named substances.

The solvents mentioned above may also be used in the polymerization mixtures. Solvents can include one or several organic solvents such as ethanol, isopropanol, n-propanol, dipropylene glycol methyl ether and butoxyisopropanol (1,2-propylene glycol-n-butyl ether), tetrahydrofurane, phenol, methylethylketone, benzene, toluene, xylene, ethanol, isopropanol, n-propanol and/or dipropylene glycol methyl ether or water.

The fillers, if used, can be partly or completely removed from the resultant material, depending on the nature and time of treatment with the solvent. A complete removal of the filler may be preferable in certain exemplary embodiments of the present invention.

In further exemplary embodiments of the present invention, thermal treatments may be used to convert the polymer-encapsulated metal-based compounds or metal-coated polymer particles into a solid porous metal-containing material. This procedure can involve the thermal decomposition of one or more polymers and/or fillers that may be present.

In certain exemplary embodiments of the present invention, the solvent may be removed prior to a thermal treatment. This can be achieved by drying the polymer particles, e.g., by filtration or thermal treatment. The drying step may also be a thermal treatment of the metal-containing polymer particles. It may be carried out at temperatures in the range of about −200° C. to 300° C., or preferably in the range of about −100° C. to 200° C., or more preferably in the range of about −50° C. to 150° C., or about 0° C. to 100° C., or even more preferably about 50° C. to 80° C. The solvents may also be removed by evaporation at room temperature. Drying may also be performed by spray drying, freeze drying, filtration, or similar conventional methods.

The decomposition may be achieved by a thermal treatment at elevated temperatures, which can be from about 20° C. to about 4000° C., or preferably from about 100° C. to about 3500° C., or more preferably from about 100° C. to about 2000° C., or even more preferably from about 150° C. to about 500° C. The thermal treatment can optionally be performed under a reduced pressure or a vacuum, or in the presence of inert or reactive gases.

A thermal treatment step can be performed under various conditions such as, e.g., in different atmospheres, for example inert atmospheres such as nitrogen, SF₆, or noble gases such as argon, or any mixtures thereof. It may also be performed in an oxidizing atmosphere that may include, e.g., oxygen, carbon monoxide, carbon dioxide, and/or nitrogen oxide. An inert atmosphere may also be mixed with reactive gases such as, e.g., air, oxygen, hydrogen, ammonia, C₁-C₆ saturated aliphatic hydrocarbons such as methane, ethane, propane and butene, mixtures thereof, or other oxidizing gases.

In certain exemplary embodiments of the present invention, the atmosphere during thermal treatment may be substantially free of oxygen. The oxygen content may be below about 10 ppm, or preferably below about 1 ppm. In certain exemplary embodiments of the present invention, a thermal treatment can be performed by laser applications such as, e.g. selective laser sintering (SLS).

The porous sintered material obtained by a thermal treatment can be further treated with suitable oxidizing and/or reducing agents, including treatment of the material at elevated temperatures in oxidizing atmospheres. Examples of oxidizing atmospheres include air, oxygen, carbon monoxide, carbon dioxide, nitrogen oxides, or similar oxidizing agents. Gaseous oxidizing agents can also be mixed with inert gases such as nitrogen or noble gases such as argon. Partial oxidation of the resultant materials can be accomplished at elevated temperatures in the range of about 50° C. to 800° C., in order to further modify the porosity, pore sizes and/or surface properties. Liquid oxidizing agents can also be used. Such oxidizing agents may include, for example, concentrated nitric acid. Concentrated nitric acid can contact the material at temperatures above room temperature. Suitable reducing agents such as, e.g., hydrogen gas may be used to reduce metal compounds to the zero-valent metal after an oxidizing conversion step.

In further exemplary embodiments of the present invention, high pressure may be applied to form the resultant material. Suitable conditions may be selected to ensure a substantially complete decomposition and removal of any polymer residues from the porous sintered metal-containing materials. These conditions may include temperature, atmosphere and/or pressure, and the polymers used to form the particles and/or fillers.

Properties of the resultant porous metal-containing materials can be influenced and/or modified in a controlled manner by oxidative and/or reductive treatment or by the incorporation of additives, fillers or other functional materials. For example, the surface properties of the resultant composite material can be rendered hydrophilic or hydrophobic by incorporating inorganic nanoparticles or nanocomposites such as layer silicates.

Coatings or bulk compositions formed from materials produced using the exemplary processes described above may be further modified by folding, embossing, punching, pressing, extruding, gathering, injection molding, etc., either before or after the materials are applied to a substrate, molded or formed. Coatings of the resultant materials may be applied in liquid, pulpy or paste form by, for example, painting, furnishing, phase-inversion, dispersing atomizing or melt coating, extruding, slip casting, dipping, or as a hot melt, followed by the thermal treatment to decompose the polymer. Dipping, spraying, spin coating, ink-jet-printing, tampon and micro drop coating or 3-D-printing and similar conventional methods can also be used. A coating of the polymeric materials can be applied to an inert substrate before the thermal decomposition, subsequently dried and then thermally treated if the substrate has a sufficient thermal stability.

Porous metal-containing materials can be produced in the form of coatings, e.g., on medical implant devices, as bulk materials, or in the form of substantially pure metal-based materials such as, e.g. mixed metal oxides. Depending on the temperature and the atmosphere chosen for the thermal treatment and/or the composition of the components used, the structure of the resultant materials can range from amorphous to crystalline. Porosity and pore sizes may be varied over a wide range by, e.g., varying the particle size of the encapsulated metal-based compounds or by varying other process parameters such as the amount and size of optional filler particles used.

Bioerodible or biodegradable coatings, or coatings and materials which may be dissolvable or may be peeled off from substrates in the presence of physiologic fluids can be produced by suitable selection of the components and processing conditions. These materials may be well-suited for forming medical implant devices or as coatings on such devices. For example, coatings that include these materials may be used for coronary implants such as stents, where the coating can also include an encapsulated marker, e.g., a metal compound having signaling properties. Such coatings may produce signals detectable by physical, chemical or biological detection methods such as x-ray, nuclear magnetic resonance (NMR), computer tomography methods, scintigraphy, single-photon-emission computed tomography (SPECT), ultrasonic, radiofrequency (RF), etc. Metal compounds used as markers may be encapsulated in a polymer shell or coated thereon and thus may not interfere with the implant material, which can also be a metal, where such interference could lead to electro-corrosion or similar problems. Coated implants may be produced with encapsulated markers, where the coating can remain permanently on the implant.

In one exemplary embodiment of the present invention, the coating may be rapidly dissolved or peeled off from a stent after implantation under physiologic conditions, allowing a transient marking to occur.

Materials that can dissolve under physiological conditions may include magnesium-based materials, such as those described in the examples below, and they may further be loaded with markers and/or therapeutically active ingredients.

In certain exemplary embodiments of the present invention, therapeutically active metal-based compounds may be used in forming the resultant materials or they may be loaded onto these materials. These compounds can be encapsulated in bioerodible or resorbable porous sintered metal-containing matrices, which may allow for a controlled release of the active ingredient under physiological conditions. Production of coatings or materials with specific porosities may allow infiltration with therapeutically active agents, which can then be resolved or extracted in the presence of physiologic fluids. This can allow for the production of medical implants that provide, e.g., a controlled release of active agents. Examples of such implants include, but are not limited to, drug eluting stents, drug delivery implants, or drug eluting orthopaedic implants.

Materials produced in accordance with the exemplary embodiments of the present invention described above may be used to form optionally coated porous bone and tissue grafts (erodible and non-erodible), optionally coated porous implants and joint implants, as well as porous traumatologic devices such as, e.g., nails, screws or plates, optionally with enhanced engraftment properties and therapeutic functionality, and/or with excitable radiation properties that may be used for local radiation therapy of tissues and organs.

The porous sintered metal-containing materials may also be used in non-medical applications, including but not limited to the production of sensors with porous textures for venting of fluids; porous membranes or filters for nano-filtration, ultrafiltration or microfiltration, as well as mass separation of gases. Porous metal-coatings with controlled reflection and refraction properties may also be produced from these materials.

Exemplary embodiments of the present invention will now be further described by way of the following non-limiting examples. Analyses and parameter determination in these examples were performed by the following methods:

Particle sizes are provided as mean particle sizes, as determined on a CIS Particle Analyzer (Ankersmid) by the TOT-method (Time-Of-Transition), X-ray powder diffraction, or TEM (Transmission-Electron-Microscopy). Average particle sizes in suspensions, emulsions or dispersions were determined by dynamic light scattering methods. Average pore sizes of the materials were determined by SEM (Scanning Electron Microscopy). Porosity and specific surface areas were determined by N₂ or He absorption techniques, according to the BET method.

### EXAMPLE 1

In a miniemulsion polymerization reaction, 5.8 g of deionized water, 5.1 mM of acrylic acid (obtained from Sigma Aldrich), 0.125 mol of methylmethacrylic acid MMA, (obtained from Sigma Aldrich) and 0.5 g of a 15 wt.-% aqueous solution of a surfactant (SDS, obtained from Fischer Chemical) were introduced into a 250 ml four-neck flask equipped with a reflux condenser under a nitrogen atmosphere. The nitrogen flow was 2 l per minute. The reaction mixture was stirred at 120 rpm for about 1 hour in an oil bath at 85° C., resulting in a stable emulsion. To the emulsion, 0.1 g of a homogenous ethanolic magnesium oxide sol (at a concentration of 2 g per liter) having an average particle size of 15 nm, prepared from 100 ml of a 20 weight-% solution of magnesium acetate tetrahydrate (Mg(CH₃COO)₂×4H₂O in ethanol and 10 ml of a 10% nitric acid at room temperature, were added and the mixture was stirred for another 2 hours. A starter solution comprising 200 mg of potassium peroxodisulphate in 4 ml of water was then slowly added over a time period of 30 minutes. After 4 hours of stirring, the mixture was neutralized to a pH of 7 and the resulting miniemulsion including PMMA-encapsulated magnesium oxide particles was cooled to room temperature.

The average particle size of the encapsulated magnesium oxide particles in the emulsion was about 100 nm, as determined by dynamic light scattering. The emulsion containing the encapsulated magnesium oxide particles was sprayed onto a metallic substrate made of stainless steel 316 L with an average coating weight per unit area of 4 g/m², dried under ambient conditions and subsequently transferred into a tube furnace and treated at 320° C. in an air atmosphere for 1 hour. After cooling to room temperature, the sample was analyzed by scanning electron microscopy (SEM), revealing that a porous magnesium oxide layer about 5 nm thick with a mean pore size of about 6 nm had formed.

### EXAMPLE 2

A stable miniemulsion of acrylic acid and methylmethacrylic acid was prepared as described in Example 1 above. The emulsion was polymerized upon addition of a starter solution as also described in Example 1. In contrast to the procedure described in Example 1, the ethanolic magnesium oxide sol was added after the polymerization was completed and the emulsion had been cooled to room temperature. After addition of the magnesium oxide, the reaction mixture was stirred for 2 hours. The resulting dispersion of PMMA capsules coated with magnesium oxide was subsequently sprayed onto a metallic substrate made of stainless steel 316 L with an average coating weight per unit area of about 8 g/m². After drying under ambient conditions, the sample was transferred into a tube furnace and treated under oxidative conditions in an air atmosphere at a temperature of 320° C. for 1 hour. An SEM analysis revealed a porous magnesium oxide layer having a mean particle size of about 140 nm.

### EXAMPLE 3

A miniemulsion was prepared as described in Example 1 above, using only 0.25 g of the 15 wt.-% aqueous SDS solution as a surfactant, leading to larger PMMA capsules. As described in Example 1, a magnesium oxide sol was added to the monomer emulsion, which was subsequently polymerized to yield PMMA-encapsulated magnesium oxide particles having a mean particle size of about 400 nm. The resulting dispersion was sprayed onto a metallic substrate made of stainless steel 316 L with an average coating weight per unit area of about 6 g/m².and, This coating was dried at room temperature and subsequently thermally treated as described in Example 1. An SEM analysis revealed that the resulting porous coating of magnesium oxide had an average pore size of about 80 nm.

### EXAMPLE 4

A miniemulsion of monomers was prepared and subsequently polymerized as described in Example 2 above. A lower amount of surfactant was used as described in Example 3, i.e., 0.25 g of the 15 wt.-% aqueous SDS solution was used instead of 0.5 g as in Example 1. The magnesium sol was then added to the dispersion of polymer particles and the mixture was stirred for 2 hours. The average particle size of the PMMA capsules coated with magnesium oxide was observed to be about 400 nm.

The resulting dispersion was sprayed onto a metallic substrate (stainless steel 316 L) with average coating weight per unit area 6 g/m², and subsequently dried under ambient conditions. The sample was thermally treated as described in Example 2 above. The resulting porous magnesium oxide layer was observed to have an average pore size of about 700 nm.

### EXAMPLE 5

In a miniemulsion polymerization reaction, 5.8 g of deionized water, 5.1 mM of acrylic acid (obtained from Sigma Aldrich), 0.125 mol of acid (obtained from Sigma Aldrich) and 0.5 g of a 15 wt.-% aqueous solution of a surfactant (SDS, obtained from Fischer Chemical) were introduced into a 250 ml four-neck flask equipped with a reflux condenser under a nitrogen atmosphere as described in Example 1 above. The reaction mixture was stirred at 120 rpm for about 1 hour in an oil bath at 85° C., resulting in a stable emulsion. An ethanolic iridium oxide sol (having a concentration of 1 g per liter) with a mean particle size of about 80 nm was produced by vacuum-drying a 5% aqueous nanoparticle dispersion of powdered iridium oxide (purchased from Meliorum Inc., USA) and re-dispersing the powder in ethanol. 0.1 g of the sol was added to the emulsion, and the mixture was stirred for another 2 hours. A starter solution containing 200 mg of potassium peroxodisulphate in 4 ml of water was then slowly added over a time period of 30 minutes. After 4 hours, the mixture was neutralized to a pH of 7, and the resulting miniemulsion that included encapsulated iridium oxide particles was cooled to room temperature. The resulting emulsion contained encapsulated iridium oxide particles having an average particle size of about 120 nm. The emulsion was sprayed onto a metallic substrate made of stainless steel 316 L with an average coating weight per unit area of about 5 g/m², dried under ambient conditions and subsequently treated under oxidative conditions in an air atmosphere at 320° C. for 1 hour. SEM analysis revealed a 3 nm thick porous iridium oxide layer having a mean pore size of about 80 nm.

Having thus described in detail several exemplary embodiments of the present invention, it is to be understood that the invention described above is not to be limited to particular details set forth in the above description, as many apparent variations thereof are possible without departing from the spirit or scope of the present invention. The embodiments of the present invention are disclosed herein or are obvious from and encompassed by the detailed description. The detailed description, given by way of example, is not intended to limit the invention solely to the specific embodiments described.

The foregoing applications and all documents cited therein or during their prosecution (“appln. cited documents”) and all documents cited or referenced in the appln. cited documents, and all documents, references and publications cited or referenced herein (“herein cited documents”), and all documents cited or referenced in the herein cited documents, together with any manufacturer's instructions, descriptions, product specifications, and product sheets for any products mentioned herein or in any document incorporated by reference herein, are hereby incorporated herein by reference, and may be employed in the practice of the invention. Citation or identification of any document in this application is not an admission that such document is available as prior art to the present invention.

It is noted that in this disclosure and particularly in the claims, terms such as “comprises,” “comprised,” “comprising” and the like can have the meaning attributed to them in U.S. Patent law; e.g., they can mean “includes,” “included,” “including” and the like; and that terms such as “consisting essentially of” and “consists essentially of” can have the meaning ascribed to them in U.S. Patent law, e.g., they allow for elements not explicitly recited, but exclude elements that are found in the prior art or that affect a basic or novel characteristic of the invention.

What is claimed is:

1. A process for manufacturing a porous metal-containing material, comprising:
a) providing a composition comprising particles dispersed in at least one solvent, the particles comprising at least one polymer material and at least one metal-based compound;
b) removing at least a portion of the solvent from the composition; and
c) at least partially decomposing the polymer material, thereby converting the particles into the porous metal-containing material.

2. The process of claim 1, wherein the particles comprise at least one of a polymer-encapsulated metal-based compound or a polymer core at least partially coated with the at least one metal-based compound.

3. The process of claim 1, wherein the particles are produced using a solvent-based polymerization reaction.

4. The process of claim 1, wherein the particles comprise at least one metal-based compound encapsulated in at least one of a polymer shell or a polymer capsule, and wherein the particles are prepared by:
a) providing at least one of an emulsion, a suspension or a dispersion of at least one polymerizable component in at least one solvent;
b) adding the at least one metal-based compound to the at least one of the emulsion, the suspension or the dispersion; and
c) polymerizing the at least one polymerizable component.

5. The process of claim 4, wherein the at least one polymerizable component comprises at least one of a monomers, an oligomer, or a prepolymer.

6. The process of claim 4, wherein the at least one of the emulsion, the suspension or the dispersion comprises at least one surfactant.

7. The process of claim 6, wherein the at least one surfactant comprises at least one of an anionic surfactant, a cationic surfactant, a non-ionic surfactant or a zwitter-ionic surfactant.

8. The process of claim 1, wherein the particles comprise polymer cores at least partially coated by the at least one metal-based compound, and wherein the particles are prepared by:
a) providing at least one of a first emulsion, a first suspension or a first dispersion of at least one polymerizable component in at least one solvent;
b) polymerizing the at least one polymerizable component, thereby forming at least one of a second emulsion, a second suspension or a second dispersion of polymer cores;
c) adding the at least one metal-based compound into the at least one of the second emulsion, the second suspension or the second dispersion.

9. The process of claim 8, wherein the at least one polymerizable component comprises at least one of a monomers, an oligomer, or a prepolymer.

10. The process of claim 8, wherein the at least one of the emulsion, the suspension or the dispersion comprises at least one surfactant.

11. The process of claim 10, wherein the at least one surfactant comprises at least one of an anionic surfactant, a cationic surfactant, a non-ionic surfactant or a zwitter-ionic surfactant.

12. The process of claim 1, wherein the decomposing step comprises drying the composition.

13. The process of claim 1, wherein the at least one metal-based compound comprises at least one of a zero-valent metal, a metal alloy, a metal oxide, an inorganic metal salt, an organic metal salt, an alkaline metal salt, an alkaline earth metal salt, a transition metal salt, an organometallic compound, a metal alkoxide, a metal acetate, a metal nitrate, a metal halide, a semiconductive metal compound, a metal carbide, a metal nitride, a metal oxynitride, a metal carbonitride, a metal oxycarbide, a metal oxynitride, a metal oxycarbonitrides, a metal-based core-shell nanoparticle, a metal-containing endohedral fullerene or an endometallofullerene.

14. The process of claim 13, wherein the at least one metal-based compound has a form of at least one of a nanocrystalline particle, a microcrystalline particle, or a nanowire.

15. The process of claim 1, wherein the at least one metal-based compound has a form of at least one of a colloidal particle or a sol.

16. The process of claim 1, wherein an average particle size of the at least one metal-based compound is between about 0.7 nm and 800 nm.

17. The process of claim 1, wherein the polymer material comprises at least one of poly(meth)acrylate, polymethylmethacrylate (PMMA), unsaturated polyester, saturated polyester, polyolefine, polyethylene, polypropylene, polybutylene, alkyd resin, epoxy-polymer, epoxy-resin, polyamide, polyimide, polyetherimide, polyamideimide, polyesterimide, polyesteramideimide, polyurethane, polycarbonate, polystyrene, polyphenol, polyvinylester, polysilicone, polyacetale, cellulose acetate, polyvinylchloride, polyvinyl acetate, polyvinyl alcohol, polysulfone, polyphenylsulfone, polyethersulfone, polyketone, polyetherketone, polybenzimidazole, polybenzoxazole, polybenzthiazole, polyfluorocarbons, polyphenylenether, polyarylate, cyanatoester-polymere, or a copolymer of any of the foregoing.

18. The process of claim 17, wherein the polymer material is prepared from at least one of a suitable monomer, a suitable oligomer or a suitable prepolymer.

19. The process of claim 1, wherein the polymer material comprises an elastomeric polymer substance comprising at least one of polybutadiene, polyisobutylene, polyisoprene, poly(styrene-butadiene-styrene), polyurethane, polychloroprene, silicone, or a copolymer.

20. The process of claim 19, wherein the polymer material is prepared from at least one of a suitable monomer, a suitable oligomer or a suitable prepolymer.

21. The process of claim 1, wherein the metal-based compound is encapsulated in at least one of a plurality of shells or a plurality of layers of organic material.

22. The process of claim 1, further comprising adding at least one additive to the composition.

23. The process of claim 22, wherein the at least one additive comprises at least one of a filler, an acid, a base, a crosslinker, a pore-forming agent, a plasticizer, a lubricant, a flame resistant material, a glass, a glass fiber, a carbon fiber, cotton, a fabric, a metal powder, a metal compound, silicon, silicon oxide, a zeolite, a titanium oxide, a zirconium oxide, an aluminium oxide, an aluminium silicate, talcum, graphite, soot, a phyllosilicate, a biologically active compound, or a therapeutically active compound.

24. The process of claim 1, wherein the decomposing step comprises performing a thermal treatment at a temperature in the range of about 20° C. to 4000° C.

25. The process of claim 24, wherein the thermal treatment is performed under at least one of a reduced pressure or a vacuum.

26. The process of claim 24, wherein the thermal treatment is performed at least one of under an inert gas atmosphere or in the presence of at least one reactive gas.

27. The process of claim 1, further comprising at least one of applying the composition to a substrate or molding the composition before at least partially decomposing the polymer material.

28. A porous metal-containing material comprising at least one section formed by:
a) providing a composition comprising particles dispersed in at least one solvent, the particles comprising at least one polymer material and at least one metal-based compound;
b) removing at least a portion of the solvent from the composition; and
c) at least partially decomposing the polymer material, thereby converting the particles into the at least one section.

29. The porous metal-containing material of claim 28, wherein the material has a form of a coating.

30. The porous metal-containing material of claim 28, wherein the material has a the form of a bulk material.

31. The porous metal-containing material of claim 28, wherein the material is bioerodible in the presence of physiologic fluids.

32. The porous metal-containing material of claim 28, wherein the material is at least partially dissolvable in the presence of physiologic fluids.

33. The porous metal-containing material of claim 28, wherein an average pore size of the material is between about 1 nm and about 400 μm.

34. The porous metal-containing material of claim 28, wherein an average porosity of the material is between about 30% to about 80%.

35. A medical implant device comprising a porous metal-containing material formed by:
a) providing a composition comprising particles dispersed in at least one solvent, the particles comprising at least one polymer material and at least one metal-based compound;
b) removing at least a portion of the solvent from the composition; and
c) at least partially decomposing the polymer material, thereby converting the particles into the porous metal-containing material.
